(19) United States
(12) Patent Application Publication
(10) Pub. No.: US 2005/0077057 A1
(43) Pub. Date: Apr. 14, 2005

(54) Fire truck booster pump

(75) Inventor: Michael A. Laskaris, Collegeville, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Hale Products, Inc.

(21) Appl. No.: 10/963,376

(22) Filed: Oct. 12, 2004

Related U.S. Application Data
(60) Provisional application No. 60/510,354, filed on Oct. 10, 2003.

(51) Int. Cl. A62C 35/00; A62C 27/00; A62C 25/00; A62C 29/00

(52) U.S. Cl. 169/52; 169/24; 169/13

(57) ABSTRACT

A booster pump for maintaining a fluid pressure at an inlet of a primary pump above a cavitation fluid pressure includes a suction hose, a booster tube, a primary pump hose and a bleed hose. The suction hose has a suction end and a feed end. The booster tube includes inlet and outlet ends and a nozzle. The inlet end is connected to the feed end. The primary pump hose includes a first end and a second end and the first end is connected to the outlet end while the second end is connected to the inlet of the primary pump. The bleed hose includes a main end and a boost end with the main end being connected to the outlet of the primary pump and the boost end being connected to the nozzle. The bleed hose selectively diverts a bleed fluid portion from the primary pump for injection into the booster tube.

### CROSS-REFERENCE TO RELATED APPLICATIONS

This application claims the benefit of U.S. Provisional Patent Application No. 60/510,354, filed Oct. 10, 2003 and entitled “Fire Truck Auxiliary Front Bumper Pump”.

### BACKGROUND OF THE INVENTION

The present application relates to a booster pump for a fire truck and more particularly, to a booster pump that is preferably mounted to or near a front bumper of the fire truck to provide a fluid pressure at an inlet of a primary pump of the fire truck that is generally maintained at a level to prevent cavitation in the primary pump and to increase the total volumetric fluid outlet flow from the primary pump in specific situations.

A fire truck is typically equipped with a front supply hose, or, infrequently a rear supply hose, that may be connected to a water source to supply water for fire suppression. The front supply hose is generally secured to a front bumper of the fire truck while the rear supply hose is secured to a rear bumper. The front supply hose is preferred because a driver can easily maneuver the front of the fire truck into a position adjacent to a generally static water source to attach an inlet end of the supply hose to the water source. In contrast, a side connection, located at a mid-ship of the fire truck, is generally more difficult for a driver to position adjacent the water source. The side connection is generally more difficult to position adjacent the water source because a driver has limited sight lines to the side or mid-ship of the fire truck when compared to the front bumper of the truck.

The distance between the front supply hose and a main pump is relatively long because of the length of the fire truck and the location of the main pump at the mid-ship of the fire truck. Significant pressure losses may be experienced between the suction end of the front supply hose and an inlet of the main pump when compared to supplying water at the mid-ship or side connection. In addition, because of additional plumbing that is required to traverse the distance from the front bumper to the mid-ship pump and the circuitous route of the plumbing between the front bumper and the mid-ship pump, pressure losses when utilizing the front suction hose may be further impacted. The pressure loss when utilizing the front supply hose is not only impacted by the distance but by the size of the piping or plumbing that runs between the front bumper and the mid-ship pump, which traverses the front portion of the truck, which has limited space for plumbing. Accordingly, although the front supply hose is generally easier to locate relative to the water source, the potential pressure losses that may result can potentially cause cavitation in the main pump when using the front supply hose. The reduced pressure may result in a significant negative pressure at an inlet of the main pump, which may result in the cavitation. Cavitation occurs when the rate of rotation of the main pump is increased without an increase in pressure occurring at the main pump outlet. When a pump operates under cavitation, the pump operates inefficiently and the total fluid output of the pump decreases. Therefore, there is less extinguishing fluid flowing out of a fire hose for extinguishing a fire when the fire truck pump operates under cavitation.

The booster pump for the fire truck of the present application is designed to increase a volumetric input fluid flow in the plumbing attached to the main pump inlet such that the pressure at the inlet is positive or at least above a cavitation pressure, which may be a slightly negative gauge pressure. The volumetric input fluid flow and inlet fluid pressure is preferably increased at the inlet of the main pump by injecting a bleed fluid portion into the fluid flowing between the water source and the main pump that is a diverted portion of the total outlet fluid flow from the main pump. The booster pump preferably regulates the inlet fluid pressure of the main pump such that the pressure is positive or above the cavitation fluid pressure to reduce or eliminate cavitation in the primary pump and to increase a total extinguishing fluid flow from the fire truck.

### BRIEF SUMMARY OF THE INVENTION

A booster pump for a fire truck for maintaining a fluid pressure at an inlet of a primary pump above a cavitation pressure includes a suction hose having a suction end and a feed end. A booster tube includes inlet and outlet ends and a nozzle between the inlet and outlet ends. The inlet end is connected to the feed end of the suction hose. A primary pump hose includes first and second ends, wherein the first end is connected to the outlet end of the booster tube and the second end is connected to the inlet of the primary pump. A bleed hose includes main and boost ends, wherein the main end is connected to the outlet of the primary pump and the boost end is connected to the nozzle. The bleed hose selectively diverts a bleed fluid portion of the volumetric output fluid flow from the primary pump to the nozzle. The nozzle injects the bleed fluid portion into the booster tube to regulate a fluid pressure at the inlet of the primary pump.

In another aspect, the present application is directed to a fire truck for drawing fluid through a suction hose and dispensing the fluid from a fire hose. The fire truck includes a primary pump positioned approximately at a mid-ship of the fire truck. The primary pump is supported by the fire truck and the fire hose is in fluid communication with the primary pump. A booster tube is mounted to the fire truck and is in fluid communication with the suction hose and a primary pump hose. Fluid flows from the suction hose, through the booster tube and into the primary pump hose. The primary pump hose is in fluid communication with the primary pump at an inlet of the primary pump. A bleed hose is in fluid communication with the primary pump and the booster tube. The bleed hose diverts a bleed fluid portion of an output fluid flow from the primary pump and injects the bleed fluid portion into fluid flowing through the booster tube.

In a further aspect, the present application is directed to a method for boosting a volumetric output fluid flow of a primary pump of a fire truck when drawing fluid from a suction hose by mounting a booster tube between a suction end of the suction hose and an inlet of the primary pump. The primary pump and the booster tube are in fluid communication through a primary pump hose and a bleed hose. The volumetric output fluid flow is boosted by inserting the suction end of the suction hose into a fluid source, drawing fluid from the fluid source using the primary pump through the suction hose, through the booster tube, through the primary pump hose and into the primary pump, drawing a bleed fluid portion of the fluid flowing out of the primary pump into the bleed hose and injecting the bleed fluid portion into the fluid flowing through the booster tube.

### BRIEF DESCRIPTION OF THE SEVERAL VIEWS OF THE DRAWINGS

The foregoing summary, as well as the following detailed description of preferred embodiments of the fire truck booster pump of the present invention, will be better understood when read in conjunction with the appended drawings. For the purpose of illustrating the preferred embodiments of the present invention, there are shown in the drawings embodiments which are presently preferred. It should be understood, however, that the invention is not limited to the precise arrangements and instrumentalities shown. In the drawings:

FIG. 1 is a side elevational view of a fire truck with a booster pump in accordance with the preferred embodiments of the present application;

FIG. 1A is a schematic block diagram of the fluid flow through the fire truck with the booster pump of FIG. 1;

FIG. 2 is a magnified, right-side elevational view of the front of the fire truck with the booster pump shown in FIG. 1;

FIG. 3 is a cross-sectional view of a first preferred embodiment of a booster tube of the booster pump of the present application; and

FIG. 4 is a cross-sectional view of a second preferred embodiment of a booster tube of the booster pump of the present application.

### DETAILED DESCRIPTION OF THE INVENTION

Certain terminology is used in the following description for convenience only and is not limiting. The words “right”, “left,” “lower,” and “upper” designate directions in the drawings to which reference is made. The words “inwardly” and “outwardly” refer to directions toward and away from, respectively, the geometric center of the booster pump, fire truck and designated parts thereof. The terminology includes the above-listed words, derivatives thereof and words of similar import.

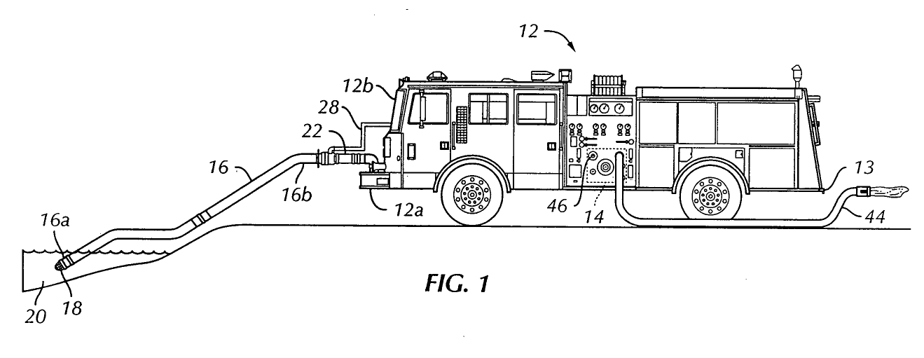

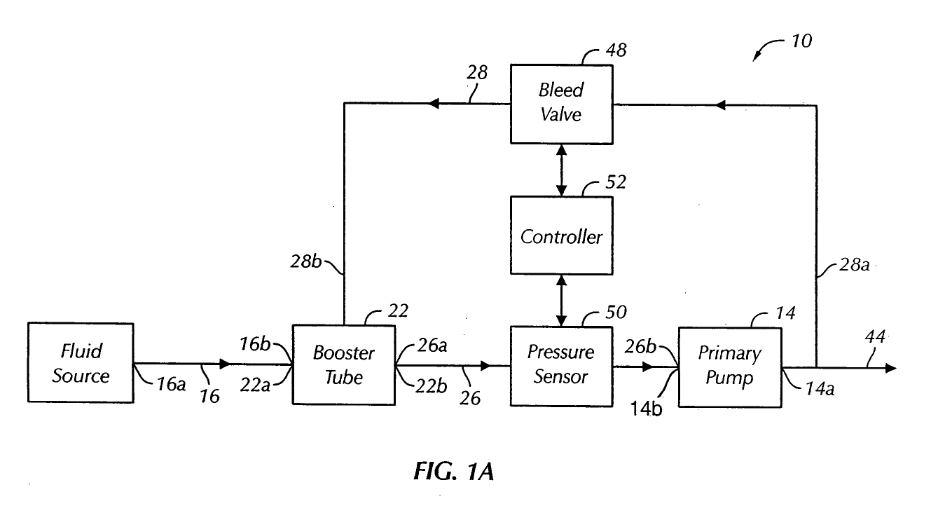

Referring to the drawings in detail, wherein like numerals indicate like elements throughout, there is shown, in FIGS. 1-4, first and second preferred embodiments of a booster pump, generally designated 10, for a fire truck 12 for maintaining a fluid pressure at an inlet 14b of a primary pump 14 above a cavitation fluid pressure. In the preferred embodiments, the primary pump 14 is comprised of a main or mid-ship pump 14 that is typically located at a mid-ship or central portion of the fire truck 12. The primary pump 14 is preferably located at the central portion of the fire truck 12 because the primary pump 14 is typically heavy and the central location aids in centering and balancing the fire truck 12. However, one having ordinary skill in the art will realize that the primary pump 14 is not necessarily mounted at the mid-ship of the fire truck 12 and may be mounted nearly anywhere to the fire truck 12 or may be comprised of a pump that is not associated with the fire truck 12 but may be used with the preferred booster pumps 10 described in the present application.

The cavitation pressure at the inlet 14b of the primary pump 14 is a fluid pressure that causes cavitation in the primary pump 14. When fluid pressure at the inlet 14b is at or below the cavitation pressure, the primary pump 14 operates less efficiently or under cavitation. When the fluid pressure at the inlet 14b is above the cavitation pressure, the primary pump 14 typically operates efficiently and without potentially damaging cavitation. The cavitation pressure varies depending upon the type and size of the primary pump 14, the conditions within which the primary pump 14 is operating and/or the type of fluid flowing through the primary pump 14 and its plumbing. For example, fluid with a relatively high temperature causes the fluid to cavitate at a higher pressure or for the pump to run under cavitation at a relatively higher pressure. The cavitation pressure also varies with the pump operating speed and discharge pressure. The cavitation pressure is typically slightly negative but is not necessarily slightly negative and typically depends upon a number of different factors for a specific pump. However, cavitation typically does not occur when the fluid pressure at the inlet 14b of the primary pump 14 is positive, assuming the temperature of the fluid is below the boiling point of the fluid.

Referring to FIGS. 1-4, in the preferred embodiments, a suction hose 16 includes a suction end 16a and a feed end 16b. The suction hose 16 is preferably constructed of a typical section of fire hose of nearly any type and may be generally flexible or rigid depending upon the application. In addition, the suction hose 16 may be comprised of a single length of hose or may be comprised of several lengths of hose connected together. The suction hose 16 preferably includes a fluid strainer 18 mounted to the suction end 16a, which is insertable into a fluid source 20. The fluid strainer 18 preferably filters or strains chunks or large pieces of material from entering the suction hose 16 during operation to generally prevent damage to the primary pump 14 or booster pump 10. One having ordinary skill in the art will realize that the fluid strainer 18 is not required for operation of the booster pump 10 of the present application but is preferred to prevent foreign objects from entering the suction hose 16.

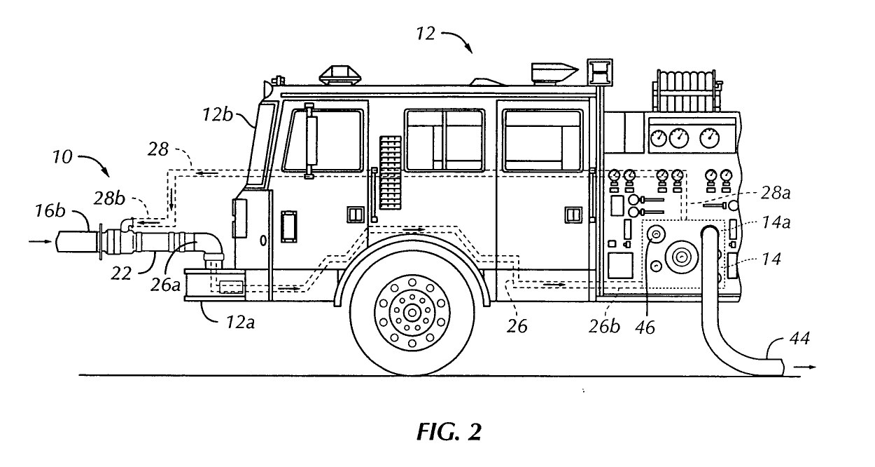

Referring to FIGS. 1-2, a booster tube 22 includes inlet and outlet ends 22a, 22b and a nozzle 24 between the inlet end 22a and the outlet end 22b. The inlet end 22a is connected to the feed end 16b of the suction hose 16. In the preferred embodiments, the booster tube 22 is pivotally mounted to a front bumper 12a of the fire truck 12 but is not limited to being pivotally mounted to the front bumper 12a and may be fixed to a front portion of the fire truck 12 behind the front bumper 12a, removable from the front bumper 12a, fixed to a rear bumper 13 or positioned nearly anywhere in the fluid flow between the suction hose 16 and the inlet 14b of the primary pump 14. Pivotally mounting the booster tube 22 to the front bumper 12a of the fire truck 12 in the preferred embodiments permits a fire fighter to quickly deploy the suction hose 16 into a fluid source 20 and to align the suction hose 16 with the inlet end 22a of the booster tube 22. In addition, mounting the booster tube 22 to the front bumper 12a of the fire truck 12 provides relatively easy access to the booster tube 22 by the fire fighter.

Quickly deploying the suction hose 16 such that water or another fluid may be drawn into the suction hose 16 and through the booster tube 22 to the primary pump 14 is preferred such that the fire truck 12 may quickly deploy the booster pump 10 to dispense fluid onto a fire. However, one having ordinary skill in the art will realize that the booster tube 12 is not limited to being mounted to the front bumper 12a and may be mounted nearly anywhere on the fire truck 12 such that fluid flowing through the booster tube 22 may be introduced to the primary pump 14. For example, the booster pump 22 may be fixed to a portion of the fire truck 12 upstream of a fitting (not shown) that is pivotally mounted to the front bumper 12a to provide the preferred deployment advantages. In addition, one having ordinary skill in the art will realize that the booster tube 22 may not be mounted to the fire truck 12 at all and may be mounted to the fire truck plumbing between the primary pump 14 and the suction end 16a of the suction hose 16 to provide fluid to the primary pump 14, thereby increasing the fluid pressure at the inlet 14b of the primary pump 12 (as will be described in greater detail below).

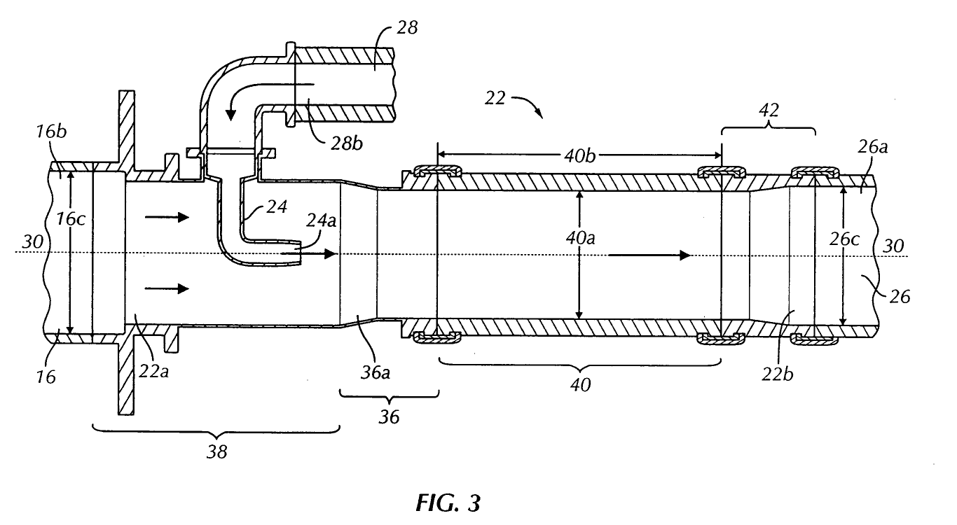

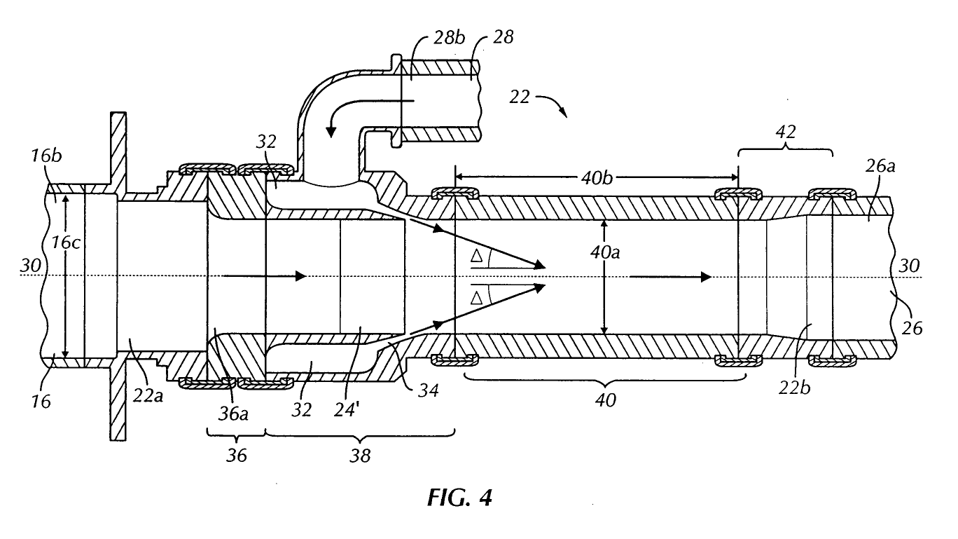

Referring to FIGS. 3 and 4, in the first and second preferred embodiments, the booster tube 22 is constructed of a cast iron, stainless steel, bronze, rigid polymeric or other similar material that is generally durable and not subject to significant corrosion during use. In addition, these materials typically provide sufficient strength to withstand the normal operating conditions of the booster tube 22. However, the booster tube 22 is not limited to constructions utilizing the above-linked materials and may be constructed of nearly any material that is able take on the general shape of the booster tube 22, withstand the typical loads introduced into the booster tube 22 and perform in the normal operating conditions of the booster tube 22. For example, the booster tube 22 may be constructed of an aluminum material or nearly any other material using nearly any processing method that produces a booster tube 22 that fulfills the above-listed features of the booster tube 22.

Referring to FIGS. 1A and 2, a primary pump hose 26 includes a first end 26a and a second end 26b. The first end 26a is connected to the outlet end 22b of the booster tube 22 and the second end 26b is connected to the inlet 14b of the primary pump 14. In the preferred embodiment, the primary pump hose 26 is constructed of a series of pipes that fluidly connect the booster tube 22 to the primary pump 14. The series of pipes of the primary pump hose 26 may be comprised of various diameter pipes and include various bends to traverse the distance between the front bumper 12a and the primary pump 14, which is generally mounted at the mid-ship of the fire truck 12. The various diameter pipes and bent joints are typically required because of limited space in the front of the fire truck 12. The typical primary pump hose 26 results in fluid pressure loss between the front bumper 12a and the main pump 14 because of the bending path and various diameter pipes comprising the typical primary pump hose 26. One having ordinary skill in the art will realize that the primary pump hose 26 is not necessarily comprised of a plurality of various diameter pipes having various bends therein to traverse the distance between the front bumper 12a and the primary pump 14. Specifically, a single diameter pipe that extends along a straight line path between the front bumper 12a and the primary pump 14 would be preferred to reduce losses in pressure between the front bumper 12a and the primary pump 14.

Referring to FIGS. 1A-4, at an outlet 14a of the primary pump 14, a bleed fluid portion is separated from a main fluid outlet portion and is recycled through a bleed hose 28 to the booster tube 22. The main fluid outlet portion flows out of the primary pump 14 and typically into a fire hose 44 for extinguishing fires or for other uses. The bleed hose 28 includes a main end 28a and a boost end 28b, wherein the main end 28a is connected to the outlet 14a of the primary pump 14 and the boost end 28b is connected to the nozzle 24 of the booster tube 22. The bleed hose 28 selectively diverts the bleed fluid portion from the primary pump 14 to the nozzle 24 and the nozzle 24 injects the bleed fluid portion into the booster tube 22 in the fluid flow direction to increase the flow and pressure in the booster tube 22. Injection of the bleed fluid portion into the booster tube 22 in the direction of fluid flow also preferably increases the fluid suction at the suction end 16a of the suction hose 16 and results in an increase in an extinguishing fluid flow portion that flows out of the fire hose 44 in certain situations.

Referring to FIG. 3, in the first preferred embodiment, the nozzle 24 is comprised of an L-shaped or pitot tube 24 with an injection end 24a that is positioned on an axis 30 of the booster tube 22. The injection end 24 preferably injects the bleed fluid portion into the booster tube 22 in the direction of fluid flow through the booster tube 22. The L-shaped nozzle 24 of the first preferred embodiment will be recognized by one having ordinary skill in the art as a pitot tube 24 that is often used to measure pressure within a pipe. However, the L-shaped nozzle 24 of the first preferred embodiment is utilized to inject fluid from the injection end 24a into the flow of fluid through the booster tube 22 in the direction of the fluid flow through the booster tube 22. This fluid injection into the booster tube 22 increases the fluid pressure with the booster tube 22 and typically the volumetric flow rate of the fluid as it flows out of the outlet end 22b. The increased volumetric fluid flow through the booster tube 22 preferably increases the suction and volumetric fluid flow in the suction hose 16, the pressure at the inlet 14b of the primary pump 14, reduces or eliminates cavitation and increases the outlet volumetric fluid flow out of the primary pump 14.

Referring to FIG. 4, in the second preferred embodiment, the nozzle 24′ is comprised of an annular basin 32 extending around a periphery of the booster tube 22 and a peripheral injection gap 34 opening into the booster tube 22 for injection of the bleed fluid portion into the booster tube 22. In the second preferred embodiment, the basin 32 and peripheral injection gap 34 are comprised of a portion of the booster tube 22 for injecting the bleed fluid portion into the fluid flowing through the booster tube 22. The basin 32 of the second preferred embodiment preferably surrounds the nozzle and is in fluid communication with the booster tube 22 through the peripheral injection gap 34.

One having ordinary skill in the art will realize that the nozzle 24, 24′ is not limited to the L-shaped or pitot tube 24 of the first preferred embodiment or the nozzle 24′ of the second preferred embodiment including the annular basin 32 and injection gap 34. The nozzle 24 may be comprised of nearly any injecting mechanism or configuration that is able to inject the bleed fluid portion into the fluid flowing through the booster tube 22 to increase the volumetric fluid flow through the booster tube 22 and increase the pressure at the inlet 14b of the primary pump 14 to reduce or eliminate cavitation and increase the extinguishing fluid portion flowing out of the hose 44. For example, the nozzle 24 may be comprised of a plurality of injecting nozzles (not shown) positioned around a periphery of the booster tube 22 to inject the bleed fluid portion into the fluid flowing through the tube 22.

Referring to FIGS. 3 and 4, in the preferred embodiments, the booster tube 22 includes a reducer section 36, a nozzle section 38, a throat 40 and a venturi 42. In the first preferred embodiment, fluid flows from the suction hose 16 into the nozzle section 38 where the fluid mixes with the bleed fluid portion that is injected through the injection end 24a of the nozzle 24, pressure increases in the reducer section 36, fluid flows through the throat 42 and through the venturi 42 into the primary pump hose 26. Alternatively, in the booster 22 of the second preferred embodiment, fluid flows from the inlet hose 16 into the reducer section 36 where a fluid pressure increases, into the nozzle section 38 where the bleed fluid portion mixes with the fluid in the booster tube 22 after being introduced through the peripheral injection gap 34, through the throat 40 and through the venturi 42 into the first end 26a of the primary pump hose 26. In both embodiments, the fluid flows through the primary pump hose 26 and into the inlet 14b of the primary pump 14.

Referring to FIGS. 2-4, in the preferred embodiments, the reducer section 36 is comprised of a tapered portion 36a that tapers from a suction hose diameter 16c to a throat diameter 40a. The reducer section 36 preferably increases the fluid pressure as it enters the booster tube 22. The nozzle section 38 preferably includes the nozzle 24, 24′ therein for injecting the bleed portion into the fluid flowing through the booster tube 22. The throat 40 of the first and second preferred embodiments includes the throat diameter 40a and a throat length 40b. A throat ratio is comprised of the throat length 40b divided by the throat diameter 40a.

The venturi 42 of the first and second preferred embodiments is comprised of an outwardly tapered section that tapers from the throat diameter 40a to a primary pump hose diameter 26c. A typical setup for the preferred fire truck 12 includes a suction hose diameter 16c of six and one-half inches (6½″), a throat diameter 40a of four and three-quarters inches (4¾″), a throat length 40b of fourteen inches (14″) and a primary hose diameter of five and one-quarter inches (5¼″). These dimensions are for a preferred fire truck 12 and are not limiting.

Referring to FIGS. 3 and 4, in the preferred embodiments, a relatively high-volumetric fluid flow is created at the outlet end 22b of the booster tube 22 and in the primary pump hose 26 due to the injection of the bleed fluid portion into the booster tube 22. This relatively high volumetric fluid flow is introduced into the primary pump 14 such that a fluid pressure that is above the cavitation pressure is present at this inlet of the primary pump 14. The bleed fluid portion is preferably injected into the booster tube 22 when a fluid pressure at the inlet 14b of the primary pump 14 falls to a zero or a negative value. Diverting the bleed fluid portion from the outlet 14a of the primary pump 14 when the fluid pressure at the inlet 14b scavenges a portion of the fluid flow that may be output to the fire hose 44. Accordingly, when the fluid pressure at the inlet 14b of the primary pump 14 is above the cavitation pressure, a bleed valve 48 is actuated to the closed position and all of the fluid flowing out of the outlet 14a is dispensed to the fire hose 44, as will be described in greater detail below.

Referring to FIGS. 1A-4, in the preferred embodiments, the bleed fluid portion is comprised of approximately zero to twenty-five percent (0-25%) of the total volumetric output flow from the primary pump 12. The bleed portion is not limited to being comprised of zero to twenty-five percent of the total volumetric output flow from the primary pump 14 and may be comprised of nearly any portion of the total volumetric output flow from the primary pump 14 that aids in developing a fluid pressure at the inlet 14b of the primary pump 14 that is above the cavitation pressure. That is, it is preferred that the bleed portion is comprised of a sufficient percentage of the total output flow from the primary pump 14 such that the fluid pressure at the inlet 14b of the primary pump 14 is above the cavitation pressure to generally prevent cavitation and potential damage to the primary pump 14. The booster pump 10 may be utilized in any application where an inlet fluid pressure to a pump is compromised by fluid pressure losses in upstream pump plumbing creating a negative or zero pressure at the primary pump inlet.

The preferred booster pump 10 also includes the bleed valve 48 that is connected to the bleed hose 28. The bleed valve 48 is movable between an open position and the closed position. In the open position of the bleed valve 48, fluid flow through the bleed hose 28 is at its maximum and when the bleed valve 48 is in the closed position, the fluid flow through the bleed hose 28 is at a minimum or zero. Utilizing the bleed valve 48, a user may regulate the bleed fluid portion by manipulating the bleed valve 48 to and between the open and closed positions. Accordingly, based upon various measurements of the fluid flow through the primary pump 14, booster tube 22, suction hose 16, primary pump outlet 14a and/or bleed hose 28, the bleed fluid portion may be increased or decreased to manipulate the fluid flow through the system.

In the preferred embodiments, the booster pump 10 includes a fluid pressure sensor 50 mounted to the primary pump hose 26 adjacent the second end 26b or adjacent or at the inlet 14b of the primary pump 14. The pressure sensor 50 may be comprised of nearly any type of fluid pressure sensor 50 that is generally well known to one having original skill in the art. The pressure sensor 50 is preferably utilized to measure the fluid pressure in the primary pump hose 26 adjacent the inlet 14b of the primary pump 14 to determine the fluid pressure at the primary pump inlet 14. If the pressure at the primary pump inlet is negative or zero, cavitation may occur in the primary pump 14, which may damage the primary pump 14 and impact the total volumetric fluid output flow from the primary pump 14. For example, the occurrence of cavitation may result in a fifty percent (50%) or more reduction in the total output fluid flow from the primary pump 14. Diverting up to twenty-five percent (25%) of the total output fluid flow as the bleed fluid portion and injection the bleed fluid portion into the booster tube 22 to provide a pressure at the inlet 14b of the primary pump 14 that is above the cavitation pressure allows the primary pump 14 to operate at full capacity. Accordingly, the extinguishing portion is increased by twenty-five percent (25%) in total and the primary pump 14 is not subjected to cavitation, which may damage the pump 14. Therefore, twenty-five percent (25%) more fluid flows from the fire hose 44 for extinguishing the fire with more fluid, resulting in less time to extinguish the fire.

A user may manipulate the bleed valve 48 based upon the pressure readings from the pressure sensor 50. For example, if the pressure sensor 50 indicates that a negative fluid pressure below or at the cavitation pressure is present at the inlet of the primary pump 14, the user may manually actuate the bleed valve 48 toward the open position until the pressure sensor 50 indicates a pressure above the cavitation pressure. Alternatively, if the pressure sensor 50 indicates a relatively high fluid pressure above the cavitation pressure at the inlet 14b of the primary pump 14, the user may manually move the bleed valve 48 toward the closed position such that more of the total outlet fluid flow from the primary pump 14 is extinguished through the hose 44.

In the preferred embodiments, manipulation of the bleed valve 48 may be controlled by a controller 52. The preferred controller 52 is in communication with the pressure sensor 50 and the bleed valve 48. The preferred controller 52 automatically adjusts the positioning of the bleed valve 48 to and between the open and closed positions based upon a signal from the pressure sensor 50 to regulate and fluid pressure at the inlet 14b of the primary pump 14. The preferred controller 52 manipulates the bleed valve 48 such that a pressure above the cavitation pressure is indicated by the pressure sensor 50 such that fluid is constantly flowing into the primary pump 14 and cavitation in the primary pump 14 generally does not occur. In addition, when the pressure sensor 50 indicates a relatively high pressure at the inlet 14b of the primary pump 14 or nearly any fluid pressure above the cavitation pressure, the controller 52 preferably actuates the bleed valve 48 towards the closed position such that a larger portion of the total fluid output flow from the primary pump 14 is extinguished from the hose 44. The controller 52 may be configured to control the bleed valve 48 such that the fluid pressure at the inlet 14b of the primary pump 14 is slightly positive. The positive pressure at the inlet 14b of the primary pump 14 may be preferred because of the variable nature of the cavitation pressure depending upon various fluid, pump and flow characteristics and the positive pressure at the inlet 14b of the primary pump 14 generally resulting in the primary pump 14 operating outside of cavitation.

The booster pump 10 is not limited to the inclusion of the pressure sensor 50 at the inlet 14b of the primary pump 14 or to the inclusion of the controller 52. The booster pump 10 may be operated manually by operating the bleed valve 48 based upon various measurements taken of the fluid flow through the booster pump 10, as would be obvious to one having ordinary skill in the art. However, the preferred controller 52 and pressure sensor 50 are utilized to optimize the operation of the booster pump 10 such that a user, for example, a firefighter, is able to perform alternative tasks as opposed to constantly manipulating the bleed valve 48, such as extinguishing fires, when utilizing the booster pump 10.

Referring to FIGS. 1-2, in the preferred embodiments, an extinguishing fluid portion of the total volumetric output fluid flow from the primary pump 14 is dispensed from the fire hose 44, generally for extinguishing a fire. The extinguishing fluid portion is preferably comprised of the total volumetric output fluid flow from the primary pump 14 minus the bleed fluid portion. When the primary pump 14 is operating most efficiently, the extinguishing fluid portion is typically at its maximum. Accordingly, the maximum extinguishing fluid portion or the entire outlet fluid portion from the primary pump 14 is dispensed from the fire hose 44 to extinguish fires and dispense a relatively large volume of fluid onto the fire. In certain instances where there is a relatively large volumetric fluid flow loss and fluid pressure reduction in the suction hose 16 and primary pump hose 26 due to the path of the primary pump hose 26 or the length of the suction hose 16, the extinguishing fluid portion may be increased by diverting the bleed fluid portion from the outlet 14a of the primary pump 14 for injection into the booster tube 22. The injection of the bleed fluid portion into the booster tube 22 preferably increases the pressure at the inlet 14b of the primary pump 14. The extinguishing fluid portion is not limited to being extinguished through the fire hose 44 and may be dispensed or extinguished through nearly any pipe or tube mounted to an output 14a of the primary pump 14 for nearly any purpose, for example, dispensing aircraft fuel to an aircraft or other fluid pumping and dispensing applications.

Referring to FIGS. 1-2, in the preferred embodiments, the primary pump 14 is positioned approximately at a mid-ship of the fire truck 12 and is supported by the fire truck 12. Accordingly, the primary pump 14 is transportable with the fire truck 12 such that the primary pump 14 may be moved to various fire fighting locations. One having ordinary skill in the art will realize that the primary pump 14 is not necessarily mounted at the mid-ship of the fire truck 12 and may be movable along the length of the fire truck 12 or may be releasable from the fire truck 12 such that the primary pump 14 may be transported to various locations.

In the preferred embodiments, the booster tube 22 is pivotally mounted to the front bumper 12a of the fire truck 12 but is not so limited. Pivotally mounting the booster tube 22 to the front bumper 12a permits a fire fighter to position the front bumper 12a adjacent the fluid source 20 such that fluid in the fluid source 20 may be introduced to the primary pump 14 through the suction hose 16, through the booster tube 22 and through the primary pump hose 26. Pivotal mounting of the booster tube 22 on the front bumper 12a permits relatively simple positioning of the booster tube 22 and suction hose 16 adjacent the fluid source 20, which may be difficult to find or may be difficult to access by the fire fighter. For example, if the fluid source 20 is a lake 20 having a shore that is relatively wet so that the fire truck 12 may not come into close proximity to the lake 20 for fear of becoming stuck in the mud or is obstructed by various objects, it is typically easier for a fire fighter driving the fire truck 12 to position the front bumper 12a relatively close to the water source 20 as opposed to a mid-ship inlet 46. Although the mid-ship inlet 46 may provide a more direct fluid flow path to the primary pump 14, the location of the mid-ship inlet 46 on a side of the relatively long fire truck 12 may make it difficult for a fire fighter to properly position the mid-ship inlet 46 adjacent the fluid source 20. Accordingly, the pivotal mounting of the booster tube 22 to the front bumper 12a gives the fire fighter driving the fire truck 12 a clear view through a front window 12b for positioning the booster tube 22 adjacent the fluid source 20. One having ordinary skill in the art will realize that the booster tube 22 is not limited to being pivotally mounted to the front bumper 12a and may be removable from the fire truck 12 to increase the volumetric fluid flow at the inlet 14b of the primary pump 14 when the suction hose 16 is relatively long and may be adapted to be inserted in-line to a suction hose 16 attached to the mid-ship inlet 46 when the suction hose 16 is relatively long and attached to the mid-ship inlet 46, thereby causing large pressure losses in the long hose.

Referring to FIG. 4, in the second preferred embodiment, the bleed fluid portion is injected into the fluid flowing through the booster tube 22 through the peripheral gap 34 in the nozzle section 38. In the second preferred embodiment, the nozzle gap 34 is approximately one one-hundredth to three tenths of an inch (0.01-0.3″). One having ordinary skill in the art will realize that the nozzle gap 34 is not limited to the above-listed dimensions and may have nearly any dimension depending upon the geometry of the booster tube 22 and the application within which the booster pump 10 is being utilized.

Referring to FIGS. 1-4, in operation of the preferred embodiments, the fire truck 12 is positioned such that its front bumper 12a is adjacent the fluid source 20. The fluid source 20 is typically a static body of water, for example, a pond, lake, swimming pool or other similar fluid source 20, but is not so limited. The booster tube 22 is pivoted such that the inlet end 22a is facing the fluid source 20, the feed end 16b of the suction hose 16 is connected to the inlet end 22a of the booster tube 22 and the suction end 16a, with the fluid strainer 18 mounted thereon, is positioned in the fluid source 20. The booster pump 10 and primary pump 14 are primed by introducing fluid into the primary pump 14, the primary pump hose 26, the booster tube 22, the bleed hose 28 and the suction hose 16. The primary pump 14 is powered to begin drawing fluid from the fluid source 20 through the suction hose 16, through the booster tube 22, through the primary pump hose 26 and into the primary pump 14.

Depending upon the inlet pressure at the inlet of the primary pump 14, the bleed valve 48 may be actuated to or somewhere between the closed and opened positions. Specifically, if the pressure sensor 50 indicates a negative or zero pressure at the inlet of the primary pump 14, the bleed valve 48 is actuated to the open position or to a position between the open and closed positions to draw the bleed fluid portion of the total output fluid flow from the primary pump outlet 14a into the bleed hose 28. The bleed fluid portion is injected into the fluid flowing through the booster tube 22, specifically, in the nozzle section 38, to increase the volumetric fluid flow through the booster tube 22, increase the suction and volumetric fluid flow in the suction hose 16 and increase the fluid pressure at the inlet 14b of the primary pump 14. The bleed fluid portion is manipulated using the bleed valve 48, preferably until the fluid pressure at the inlet 14b of the primary pump 14 is above the cavitation pressure. When the fluid pressure at the primary pump inlet 14b is above the cavitation pressure, the primary pump 14 typically operates relatively efficiently and the extinguishing fluid portion is dispensed through the fire hose 44 to extinguish a fire or pump the fluid to another location. In addition, cavitation typically does not result when the fluid pressure at the inlet 14b of the primary pump 14 is slightly negative, as long as the fluid pressure is above the cavitation pressure, thereby avoiding potential cavitation damage to the primary pump 14 and dispensing a relatively large volume of water out of the fire hose 44.

The controller 52 automatically monitors the fluid pressure at the inlet 14b of the primary pump 14 through the pressure sensor 50 and adjusts the bleed valve 48 such that a fluid pressure above the cavitation pressure is present at the primary pump inlet 14b. As a default, the controller 52 may control the bleed valve 48 such that the fluid pressure at the pressure sensor 50 is positive. When the pressure sensor 50 indicates a positive pressure or at least a pressure above the cavitation pressure at the inlet 14b of the primary pump 14 without injection the bleed portion into the booster tube 22, the controller 52 preferably actuates the bleed valve 48 to the closed position such that the bleed portion is zero.

Referring to FIG. 4, in the second preferred embodiment, the bleed fluid portion is injected into the booster tube 22 through the peripheral injection gap 34 at an injection angle Δ toward the booster axis 30 of the booster tube 22. In the second preferred embodiment, the injection angle Δ is between 5 and 25 degrees. One having ordinary skill in the art will realize that the injection angle Δ is not limited to the above-listed range and maybe injected at nearly any angle into the fluid flowing through the booster tube 22 to propel the fluid toward the outlet end 22b. However, the above-listed injection angle range is preferred to propel the fluid through the booster tube 22.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined by the appended claims.

1. A booster pump for a fire truck for maintaining a fluid pressure at an inlet of a primary pump above a cavitation fluid pressure, the booster pump comprising:
a suction hose including a suction end and a feed end;
a booster tube including inlet and outlet ends and a nozzle between the inlet and outlet ends, the inlet end being connected to the feed end of the suction hose;
a primary pump hose including a first end and a second end, the first end being connected to the outlet end of the booster tube, the second end being connected to the inlet of the primary pump; and
a bleed hose including a main end and a boost end, the main end being connected to an outlet of the primary pump and the boost end being connected to the nozzle, the bleed hose selectively diverting a bleed fluid portion of the volumetric output fluid flow from the primary pump to the nozzle, the nozzle injecting the bleed fluid portion into the booster tube to regulate a fluid pressure at the inlet of the primary pump.

2. The booster pump of claim 1 wherein the booster tube is pivotally mounted to a front bumper of the fire truck.

3. The booster pump of claim 1 wherein the nozzle is comprised of an L-shaped tube with an injection end that is positioned on a booster axis, the injection end injecting the bleed fluid portion into the booster tube.

4. The booster pump of claim 1 wherein the nozzle is comprised of a basin extending around a periphery of the booster tube and a peripheral injection groove opening into the booster tube for injection of the bleed fluid portion into the booster tube.

5. The booster pump of claim 1 wherein the booster tube includes a reducer section, a nozzle section, a throat and a venturi, fluid flowing from the suction hose into the reducer section, a fluid pressure increasing in the reducer section, the fluid flowing into the nozzle section and mixing with the bleed fluid portion, through the throat and through the venturi into the first end of the primary pump hose.

6. The booster pump of claim 1 further comprising:
a bleed valve connected to the bleed hose, the bleed valve being movable between an open position and a closed position.

7. The booster pump of claim 6 further comprising:
a pressure sensor mounted to the primary pump hose adjacent the second end and inlet of the primary pump; and
a controller in communication with the pressure sensor and the bleed valve, the controller automatically adjusting the positioning of the bleed valve to and between the open and closed positions based upon a signal from the pressure sensor to regulate the fluid pressure at the inlet of the primary pump.

8. The booster pump of claim 1 wherein the bleed fluid portion is comprised of approximately zero to twenty-five percent (0-25%) of the total volumetric output flow from the primary pump.

9. A fire truck for drawing fluid through a suction hose and dispensing the fluid from a fire hose, the fire truck comprising:
a primary pump positioned approximately at a mid-ship of the fire truck and supported by the fire truck, the fire hose being in fluid communication with the primary pump;
a booster tube mounted to the fire truck, the booster tube being in fluid communication with the suction hose and a primary pump hose, fluid flowing from the suction hose, through the booster tube and into the primary pump hose, the primary pump hose being in fluid communication with the primary pump at an inlet of the primary pump; and
a bleed hose in fluid communication with the primary pump and the booster tube, the bleed hose diverting a bleed fluid portion of an output fluid flow from the primary pump and injecting the bleed fluid portion into fluid flowing through the booster tube.

10. The fire truck of claim 9 further wherein the booster tube includes a nozzle portion and a throat, the bleed fluid portion being injected into the nozzle portion upstream from the throat.

11. The fire truck of claim 9 wherein the booster tube is pivotally mounted to a front bumper of the fire truck.

12. The fire truck of claim 9 further comprising:
a bleed valve connected to the bleed hose adjacent the primary pump, the bleed valve being movable between an open position and a closed position, the bleed fluid portion being a minimum value when the bleed valve is in the closed position and the bleed fluid portion being a maximum value when the bleed valve is in the open position.

13. The fire truck of claim 9 wherein the booster tube includes an injecting pitot tube therein, the pitot tube being in fluid communication with the bleed hose.

14. The fire truck of claim 9 wherein the booster tube includes a basin and a peripheral gap opening into an inside of the booster tube, the bleed fluid portion being injected into the fluid flowing through the booster tube through the peripheral gap.

15. The fire truck of claim 9 wherein the booster tube is fixed to a front portion of the fire truck behind a front bumper.

16. A method for boosting a volumetric output fluid flow of a primary pump of a fire truck when drawing fluid from a suction hose by mounting a booster tube between a suction end of the suction hose and an inlet of the primary pump, the primary pump and the booster tube being in fluid communication through a primary pump hose and a bleed hose, the method comprising the steps of:
a) inserting the suction end into a fluid source;
b) drawing fluid from the fluid source using the primary pump through the suction hose, through the booster tube, through the primary pump hose and into the primary pump;
c) drawing a bleed fluid portion of the fluid flowing out of the primary pump into the bleed hose; and
d) injecting the bleed fluid portion into the fluid flowing through the booster tube.

17. The method of claim 16 wherein the bleed fluid portion is injected into the booster tube through a peripheral injection groove that injects the bleed fluid portion at an injection angle toward a booster axis of the booster tube.

18. The method of claim 16 wherein the bleed fluid portion is injected into the booster tube through a pitot tube.

19. The method of claim 16 further comprising:
e) actuating a bleed valve between an open position and a closed position depending upon a fluid pressure at the inlet of the primary pump.

20. The method of claim 19 wherein the bleed valve is actuated to the closed position when the fluid pressure at the inlet of the primary pump is at least above a cavitation fluid pressure.

21. The method of claim 19 wherein the bleed valve is actuated to one of the open position and a position between the open and closed positions when the fluid pressure at the inlet of the primary pump is one of at a cavitation fluid pressure or below the cavitation fluid pressure.
